(19) United States
(12) Patent Application Publication
(10) Pub. No.: US 2026/0247247 A1
(43) Pub. Date: Aug. 20, 2026

(54) METHOD FOR MOBILITY MANAGEMENT, TERMINAL DEVICE, AND CHIP

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 19/645,875

(22) Filed: Apr. 13, 2026

Related U.S. Application Data
(63) Continuation of application No. PCT/CN2023/124606, filed on Oct. 13, 2023.

(51) Int. Cl. H04W 36/30

(52) U.S. Cl. CPC H04W 36/305

(57) ABSTRACT

A method for mobility management, a terminal device, and a chip are provided. The method for mobility management includes the following. A terminal device executes a layer 1 (L1)/layer 2 (L2) triggered mobility (LTM)-related procedure when a master cell group (MCG) failure recovery procedure is absent.

### CROSS REFERENCE TO RELATED APPLICATION(S)

This application is a continuation of International Application No. PCT/CN2023/124606, filed October 13, 2023, the entire disclosure of which is incorporated herein by reference.

### TECHNICAL FIELD

This disclosure relates to the field of communication, in particular to a method for mobility management, a terminal device, and a chip.

### RELATED ART

To reduce service interruption caused by radio link failure (RLF), a fast master cell group (MCG) recovery function has been introduced into a communication system. When RLF occurs on an MCG, an indication is sent to a network via a secondary cell group (SCG) link to trigger fast MCG link recovery on the network side. An MCG failure recovery procedure can minimize service interruption and improve communication stability. Therefore, it is essential to consider how to enhance the success rate of the MCG failure recovery procedure.

### SUMMARY

A method for mobility management is provided in the present disclosure. The method for mobility management includes the following. A terminal device executes a layer 1 (L1)/layer 2 (L2) triggered mobility (LTM)-related procedure when a master cell group (MCG) failure recovery procedure is absent.

A terminal device is provided in embodiments of the present disclosure. The terminal device includes a processor and a memory. The memory is configured to store a computer program. The processor is configured to invoke and execute the computer program stored in the memory, to cause the terminal device to perform the method for mobility management.

A chip is provided in embodiments of the present disclosure. The chip includes a processor. The processor is configured to invoke and execute a computer program stored in a memory, to cause a device equipped with the chip to perform the method for mobility management.

### BRIEF DESCRIPTION OF THE DRAWINGS

FIG. 1 is a schematic diagram of a communication system according to embodiments of the present disclosure.

FIG. 2 is a schematic diagram illustrating a cell handover procedure across base stations.

FIG. 3 is a schematic diagram illustrating a basic LTM procedure.

FIG. 4 is a schematic diagram illustrating fast MCG recovery.

FIG. 5 is a schematic flowchart of a method for mobility management according to an embodiment of the present disclosure.

FIG. 6 is a schematic flowchart of a method for mobility management according to another embodiment of the present disclosure.

FIG. 7 is a schematic flowchart of a method for mobility management according to yet another embodiment of the present disclosure.

FIG. 8 is a schematic block diagram of a terminal device according to an embodiment of the present disclosure.

FIG. 9 is a schematic block diagram of a terminal device according to another embodiment of the present disclosure.

FIG. 10 is a schematic block diagram of a first network device according to an embodiment of the present disclosure.

FIG. 11 is a schematic block diagram of a first network device according to another embodiment of the present disclosure.

FIG. 12 is a schematic block diagram of a first network device according to yet another embodiment of the present disclosure.

FIG. 13 is a schematic block diagram of a second network device according to an embodiment of the present disclosure.

FIG. 14 is a schematic block diagram of a communication device according to embodiments of the present disclosure.

FIG. 15 is a schematic block diagram of a chip according to embodiments of the present disclosure.

FIG. 16 is a schematic block diagram of a communication system according to embodiments of the present disclosure.

### DETAILED DESCRIPTION

The following will describe technical solutions of embodiments of the present disclosure with reference to accompanying drawings in embodiments of the present disclosure.

The technical solutions of embodiments of the present disclosure are applicable to various communication systems, for example, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) communication system, a 6th-generation (6G) communication system, or other communication systems.

Generally speaking, a conventional communication system generally supports a limited number (quantity) of connections and therefore is easy to implement. However, with the development of communication technology, a mobile communication system will not only support conventional communication but also support, for example, device-to-device (D2D) communication, machine-to-machine (M2M) communication, machine-type communication (MTC), vehicle-to-vehicle (V2V) communication, or vehicle-to-everything (V2X) communication, etc. Embodiments of the present disclosure are also applicable to these communication systems.

In an implementation, the communication system in embodiments of the present disclosure is applicable to an unlicensed spectrum, and the unlicensed spectrum may be regarded as a shared spectrum. Alternatively, the communication system in embodiments of the present disclosure is applicable to a licensed spectrum, and the licensed spectrum may be regarded as a non-shared spectrum.

Various embodiments of the present disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, a terminal device in a future evolved public land mobile network (PLMN), etc.

In embodiments of the present disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the present disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, a wireless terminal device in smart home, etc.

By way of explanation rather than limitation, in embodiments of the present disclosure, the terminal device may also be a wearable device. The wearable device may also be referred to as a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the present disclosure, the network device may be a device configured to communicate with a mobile device, and the network device may be an access point (AP) in a WLAN, or may be an evolutional Node B (eNB or eNodeB) in LTE, or a relay station or AP, or an in-vehicle device, a wearable device, a network device (gNB) in an NR network, a network device in a future evolved PLMN, a network device in an NTN, etc.

By way of explanation rather than limitation, in embodiments of the present disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the present disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

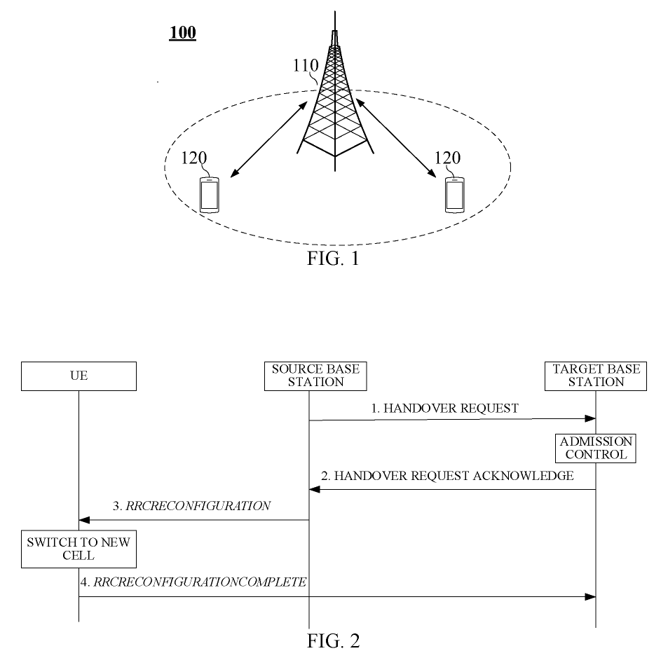

FIG. 1 exemplarily illustrates a communication system 100. The communication system includes one network device 110 and two terminal devices 120. In an implementation, the communication system 100 may include multiple network devices 110, and there may be other numbers of terminal devices 120 in a coverage area of each network device 110, which is not limited in embodiments of the present disclosure.

It may be understood that, in embodiments of the present disclosure, a device with communication functions in a network/system can be referred to as a “communication device”. Taking the communication system 100 illustrated in FIG. 1 as an example, the communication device may include a network device and a terminal device with a communication function. The network device and the terminal device may be specific devices as described above, which will not be elaborated herein. The communication device may further include other devices such as a network controller, a mobility management entity (MME), or other network entities in the communication system 100, which will not be limited in embodiments of the present disclosure.

It may be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It may be understood that, “indication” referred to in embodiments of the present disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B.

In the elaboration of embodiments of the present disclosure, the term “correspondence” may mean that there is a direct or indirect correspondence between the two, may mean that there is an association between the two, may mean a relationship of indicating and indicated or configuring and configured, etc.

To facilitate understanding of the technical solutions of embodiments of the present disclosure, related art in embodiments of the present disclosure will be elaborated below. The following related art, as an optional scheme, can be arbitrarily combined with the technical solutions of embodiments of the present disclosure, which shall all belong to the protection scope of embodiments of the present disclosure.

### I. Conventional Handover Procedure

Similar to an LTE system, an NR system supports a handover procedure of a UE in a connected state. When a user using a network service moves from one cell to another cell, or due to adjustment of a traffic load in a wireless transmission service, activation operation and maintenance, a device fault, or other reasons, in order to ensure communication continuity and service quality, the system requires transfer of the user’s communication link with an original cell to a new cell, i.e., a handover procedure is performed.

FIG. 2 is a schematic diagram illustrating a cell handover procedure across base stations. The general procedure is as follows.
1. A source base station triggers handover based on a layer 3 (L3) measurement result reported by a terminal, and sends a handover request to a target cell via an Xn interface.
2. A target base station receives the handover request from the source base station, provides a radio resource control (RRC) configuration of the target cell, and feeds the RRC configuration back to the source base station as part of handover request acknowledge.
3. The source base station sends an RRC reconfiguration (RRCReconfiguration) to a UE to indicate the UE to initiate a handover procedure, and the RRC configuration information is used for accessing the target cell.
4. The UE accesses the target cell and sends RRC reconfiguration complete (RRCReconfigurationComplete) to the target cell. In order to establish uplink synchronization with the target cell, the UE needs to initiate a random access procedure to the target cell upon receiving a handover command.

### II. Layer 1 (L1)/Layer 2 (L2) Triggered Mobility (LTM) Procedure

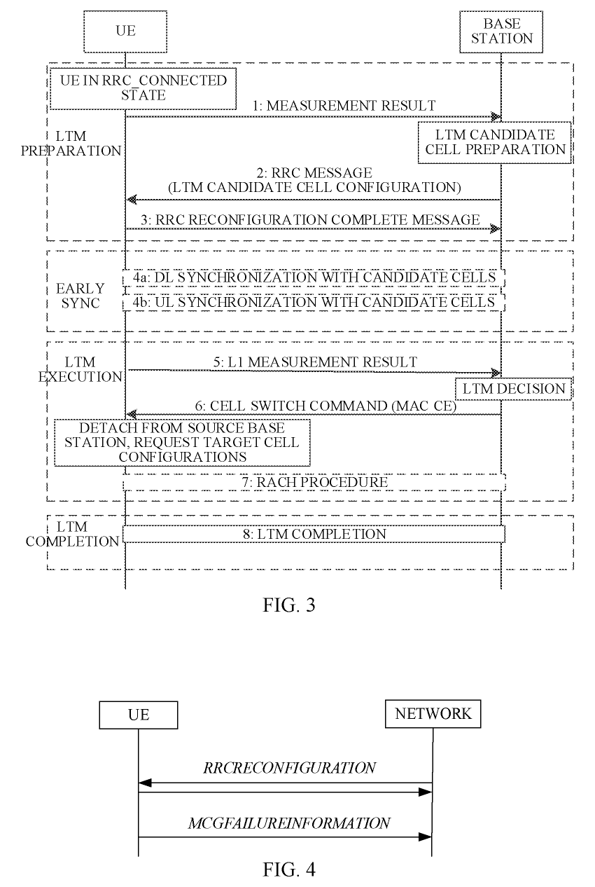

In related art, a handover procedure is generally triggered by an L3 signaling (RRCReconfiguration). To further reduce the latency of an L3 handover procedure, cell handover triggered based on an L1/L2 signaling, i.e., LTM, will be supported in an NR R18 mobility project. FIG. 3 is a schematic diagram illustrating a basic LTM procedure. As illustrated in FIG. 3, the LTM mainly includes the following steps.
1. A UE reports an L3 measurement result to a base station, and the base station determines to initiate an LTM procedure and triggers candidate cell preparation.
2. The base station sends an RRC message (i.e., an RRCReconfiguration message) containing an LTM candidate cell configuration to the UE, where there may be one or more candidate cells.
3. The UE stores the LTM candidate cell configuration and feeds back a reconfiguration complete message (i.e., an RRCReconfigurationComplete message) to a network.
4. Before receiving an LTM cell switch command, the UE may perform uplink/downlink synchronization with the candidate cell(s) in advance, to reduce interruption delay during a switch procedure.
5. The UE performs L1 measurement on each candidate cell and reports an L1 measurement result to the network.
6. The base station determines a target cell based on the L1 measurement result reported by the UE, and indicates the UE to switch to the target cell via a media access control control element (MAC CE).
7. If the UE does not have a valid tracking area (TA) for the target cell currently, the UE initiates a random access procedure to the target cell upon receiving the LTM cell switch command.
8. The UE sends indication information indicating successful LTM completion to the target cell.

### III. Fast Master Cell Group (MCG) Recovery

FIG. 4 is a schematic diagram illustrating fast MCG recovery. To reduce service interruption caused by radio link failure (RLF), a fast MCG recovery function has been introduced into a communication system. When RLF occurs on an MCG, an indication is sent to a network via a secondary cell group (SCG) link to trigger fast MCG link recovery on the network side.

During the fast MCG link recovery, a UE suspends MCG transmission of all (user) data radio bearers (DRBs) and all signaling radio bearers (SRBs), and transmits MCG failure information (MCGFailureInformation) to a secondary node (SN) via an SCG link of split SRB1 or SRB3. Then, the SN forwards the MCGFailureInformation to a master node (MN). After the MN is aware that the UE has experienced an MCG RLF, the MN can provide the UE with a new RRC configuration via the SCG link of the split SRB1 or SRB3.

In the MCGFailureInformation, the UE may carry measurement results obtained by the MN and the SN based on a current measurement configuration, to assist the network in selecting an appropriate cell for the UE to recover a radio link on the MCG side.

The UE transmits the MCG failure information to the network via the SCG link. If a primary secondary cell (PSCell) change occurs, the transmission of the MCG failure information may fail. When RLF occurs on the MCG side, the UE is unable to receive a downlink message from the MCG, and therefore, an LTM procedure for the MCG side will not be triggered. However, in this case, a radio link on the SCG side is good, the UE is still able to receive an LTM cell switch command sent by the SN, and thus an LTM procedure for the SCG side may be triggered, thereby affecting an MCG failure recovery procedure.

The technical solutions in the present disclosure are mainly aimed at addressing the issues mentioned above.

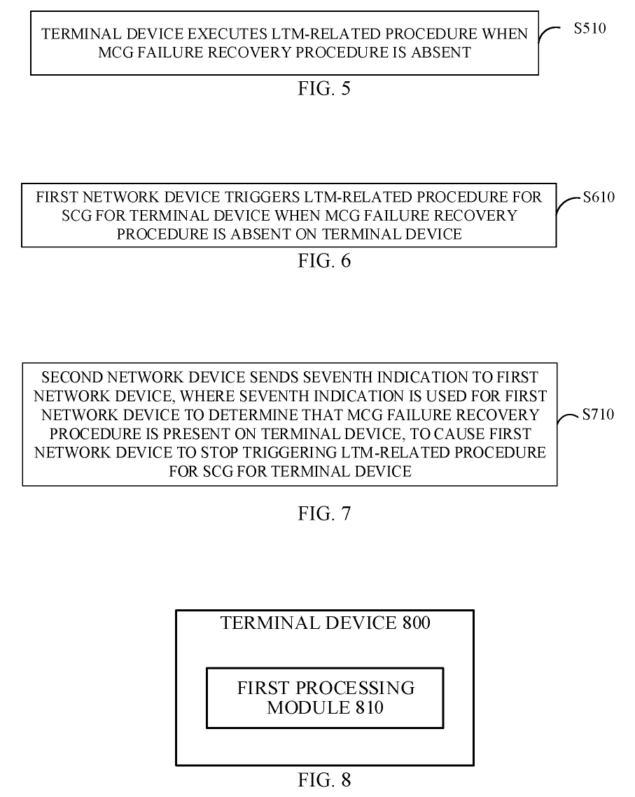

FIG. 5 is a schematic flowchart of a method for mobility management according to an embodiment of the present disclosure. The method is optionally applicable to the system as illustrated in FIG. 1, but is not limited thereto. The method includes the following.

At S510, when an MCG failure recovery procedure is absent, a terminal device executes an LTM-related procedure.

It may be understood that, the operations at S510 may include the following. When a condition for triggering the LTM-related procedure is satisfied (e.g., a related signaling is received), the terminal device autonomously determines whether the MCG failure recovery procedure is present, such that the terminal device executes the LTM-related procedure based on a determination that the MCG failure recovery procedure is absent. Alternatively, the LTM-related procedure is triggered when the MCG failure recovery procedure is absent, which means that the condition for triggering the LTM-related procedure can be satisfied only when the MCG failure recovery procedure is absent.

In the method mentioned above, for the MCG failure recovery procedure, also referred to as “MCG failure recovery process”, reference may be made to the descriptions related to the fast MCG recovery in the related art mentioned above. The MCG failure recovery procedure is absent, which can mean that the MCG failure recovery procedure is not currently triggered, or that an ongoing MCG failure recovery procedure is currently absent.

In the method mentioned above, the LTM-related procedure is executed, which can mean that the terminal device executes a handling procedure triggered by an LTM cell switch command sent by a network device.

According to the method, the LTM-related procedure can be executed by the terminal device only when the MCG failure recovery procedure is absent on the terminal device. Therefore, in the MCG failure recovery procedure, a change in a network situation caused by the LTM-related procedure can be avoided, thereby improving the success rate of the MCG failure recovery procedure.

As mentioned above, when the condition for triggering the LTM-related procedure is satisfied, the terminal device can determine whether the MCG failure recovery procedure is present, and based on this, the terminal device can determine whether to execute the LTM-related procedure. Specifically, in some embodiments, the method for mobility management may further include the following. When a first signaling is received by the terminal device, the terminal device determines whether the MCG failure recovery procedure is present, where the first signaling is used for triggering the LTM-related procedure.

In other words, when the terminal device receives the first signaling used for triggering the LTM-related procedure, the terminal device determines whether the MCG failure recovery procedure is present. If the MCG failure recovery procedure is absent, the terminal device can execute the LTM-related procedure. Optionally, if the MCG failure recovery procedure is present, the terminal device may not execute the LTM-related procedure, and/or the terminal device may execute other processing, such as RRC re-establishment. Since the triggering of the LTM-related procedure indicates that a network condition of an SCG link is poor, it may also fail to transmit MCG link failure information to the network side via the SCG link for the network to execute related configurations and operations. In this case, RRC re-establishment may be considered to recover network connectivity as soon as possible.

Exemplarily, the first signaling can include the LTM cell switch command sent by the network device, and the first signaling is an MAC CE.

The terminal device may determine whether the MCG failure recovery procedure is present according to various implementations. Exemplary implementations, including Implementation 1 and Implementation 2, are provided below.

### Implementation 1:

When the first signaling is received by the terminal device, the terminal device determines whether the MCG failure recovery procedure is present as follows. When the first signaling is received by a first protocol layer of the terminal device, the first protocol layer of the terminal device sends a first indication to a second protocol layer of the terminal device, where the second protocol layer is configured to trigger the MCG failure recovery procedure. When the first indication is received by the second protocol layer of the terminal device, the second protocol layer of the terminal device determines whether the MCG failure recovery procedure is present.

The first indication indicates to the second network device that the first signaling is received.

It can be understood that, the first protocol layer is a protocol layer for receiving the first signaling, and the second protocol layer is a protocol layer for triggering the MCG failure recovery procedure. That is, in practical applications, the MCG failure recovery procedure is triggered and controlled by the second protocol layer, and the first signaling for triggering the LTM-related procedure is received and processed by the first protocol layer. Therefore, the first protocol layer is unaware of whether an ongoing MCG failure recovery procedure is currently present. According to the processing manner provided in embodiments of the present disclosure, when the first signaling is received by the first protocol layer, the first protocol layer can interact with the second protocol layer, and the second protocol layer can determine whether the MCG failure recovery procedure is present. In this way, further confirmation can be made through the interaction between the second network device and the first network device, which can prevent the execution of the LTM-related procedure during the MCG failure recovery procedure.

Exemplarily, the first protocol layer is an MAC layer, and the second protocol layer is an RRC layer. In comparison, the RRC layer is an upper layer relative to the MAC layer. Therefore, in some descriptions, the first protocol layer may be referred to as a lower layer, and the second protocol layer may be referred to as an upper layer.

In some embodiments, the second protocol layer is configured to determine, according to a running state of a first timer, whether the MCG failure recovery procedure is present, where the first timer is started when the MCG failure recovery procedure is triggered, and the first timer is stopped when the MCG failure recovery procedure is completed or canceled.

Exemplarily, the first timer may be timer T316. Timer T316 is used for monitoring the MCG failure recovery procedure. Specifically, the second protocol layer starts T316 when the MCG failure recovery procedure is triggered, and stops T316 when MCG transmission is recovered, when a response RRCrelease message is received from the network side, or when an RRC re-establishment procedure is initiated. When T316 expires, the UE considers that the fast MCG link recovery procedure fails and ends, and thus triggers the RRC re-establishment procedure, i.e., the MCG failure recovery procedure is canceled. Therefore, whether the MCG failure recovery procedure is currently present can be accurately determined according to the running state of T316.

In some embodiments, when the MCG failure recovery procedure is absent, the terminal device can execute the LTM-related procedure as follows. Based on a determination that the MCG failure recovery procedure is absent, the second protocol layer of the terminal device initiates an LTM procedure related to the second protocol layer.

Optionally, based on a determination that the MCG failure recovery procedure is present, the second protocol layer may not initiate the LTM procedure related to the second protocol layer and/or may initiate the RRC re-establishment procedure.

For the first protocol layer, through the interaction between the second protocol layer and the first protocol layer, the first protocol layer can execute an LTM procedure related to the first protocol layer when the MCG failure recovery procedure is absent. Exemplary implementations, including Implementation 1A and Implementation 1B, are provided below.

In Implementation 1A, the method for mobility management further includes the following. Based on a determination that the MCG failure recovery procedure is present, the second protocol layer of the terminal device sends a second indication to the first protocol layer and/or initiates an RRC re-establishment procedure, where the second indication indicates the first protocol layer to cancel the LTM procedure related to the first protocol layer initiated when the first signaling is received.

Specifically, when the first signaling is received by the first protocol layer, the first protocol layer initiates the LTM procedure related to the first protocol layer and sends the first indication to the second protocol layer. When the first indication is received by the second protocol layer, the second protocol layer determines whether the MCG failure recovery procedure is present (e.g., according to the state of T316). If the MCG failure recovery procedure is absent, the second protocol layer can initiate the LTM procedure related to the second protocol layer without further indication to the first protocol layer. If the MCG failure recovery procedure is present, the second protocol layer may send the second indication to the first protocol layer to cause the first protocol layer to cancel the initiated LTM procedure related to the first protocol layer, or the second protocol layer may directly initiate the RRC re-establishment procedure to obtain a good network connection as soon as possible, or the second protocol layer may both cancel the initiated LTM procedure and initiate the RRC re-establishment procedure. While initiating the RRC re-establishment procedure, the second protocol layer stops the first timer.

Exemplarily, the LTM procedure related to the first protocol layer may include initiating a random access procedure to a target cell, applying a transmission configuration indicator (TCI) state indicated by the first signaling, resetting an MAC, etc.

Optionally, based on Implementation 1A, the method for mobility management may further include the following. When the second indication is received by the first protocol layer of the terminal device, the first protocol layer of the terminal device initiates a random access procedure to a network device of a source PSCell and/or falls back to a configuration related to the source PSCell. The first protocol layer of the terminal device initiates the random access procedure to the network device of the source PSCell and/or falls back to the configuration related to source PSCell, such that the first protocol layer can recover to its original configuration, thereby canceling the LTM-related procedure.

In Implementation 1B, the method for mobility management further includes the following. Based on a determination that the MCG failure recovery procedure is absent, the second protocol layer of the terminal device sends a third indication to the first protocol layer of the terminal device. When the third indication is received by the first protocol layer of the terminal device, the first protocol layer of the terminal device initiates the LTM procedure related to the first protocol layer.

The third indication indicates to the first protocol layer that the MCG failure recovery procedure is absent.

Specifically, when the first signaling is received by the first protocol layer, the first protocol layer sends the first indication to the second protocol layer. At this point, the LTM procedure related to the first protocol layer is not initiated. When the first indication is received by the second protocol layer, the second protocol layer determines whether the MCG failure recovery procedure is present (e.g., according to the state of T316). If the MCG failure recovery procedure is absent, the second protocol layer can initiate the LTM procedure related to the second protocol layer, and send the third indication to the first protocol layer to cause the first protocol layer to initiate the LTM procedure related to the first protocol layer.

Optionally, if the MCG failure recovery procedure is present, the second protocol layer may not execute other processing for the first indication, such that neither the first protocol layer nor the second protocol layer executes the LTM procedure.

Optionally, if the MCG failure recovery procedure is present, the second protocol layer may also initiate an RRC re-establishment procedure. That is, the method for mobility management may further include the following. Based on a determination that the MCG failure recovery procedure is present, the second protocol layer of the terminal device initiates the RRC re-establishment procedure. Through the initiation of RRC re-establishment, the network connectivity can be recovered as soon as possible, even when the SCG link condition is poor.

### Implementation 2:

The method for mobility management further includes the following. When the MCG failure recovery procedure is triggered by the second protocol layer of the terminal device, the second protocol layer of the terminal device sends a fourth indication to the first protocol layer of the terminal device, where the fourth indication is used for the first protocol layer of the terminal device to determine, when receiving the first signaling, whether the MCG failure recovery procedure is present.

In other words, when the second protocol layer triggers the MCG failure recovery procedure, the second protocol layer sends the fourth indication to the first protocol layer. When the first signaling is received by the first protocol layer, the first protocol layer can determine, based on the fourth indication, whether the MCG failure recovery procedure is present.

In some embodiments, when the MCG failure recovery procedure is triggered by the second protocol layer of the terminal device, the second protocol layer of the terminal device sends the fourth indication to the first protocol layer of the terminal device as follows. When the MCG failure recovery procedure is triggered by the second protocol layer of the terminal device, the second protocol layer of the terminal device sends the fourth indication to the first protocol layer of the terminal device when a candidate cell configuration for an SCG side-LTM is present.

Optionally, if the candidate cell configuration for the SCG side-LTM is absent, the second protocol layer does not need to perform any special processing for LTM when the MCG failure recovery procedure is triggered.

Since an LTM procedure for the MCG side is not triggered during the MCG failure recovery procedure, the fourth indication is configured to be sent to the first protocol layer when the candidate cell configuration for the SCG side-LTM is present, which can avoid unnecessary inter-layer interactions and waste of processing resources.

In some embodiments, the method for mobility management further includes the following. When the MCG failure recovery procedure is completed or canceled, the second protocol layer of the terminal device sends a fifth indication to the first protocol layer, where the fifth indication is used for the first protocol layer of the terminal device to determine, when receiving the first signaling, whether the MCG failure recovery procedure is present.

Specifically, the first protocol layer can determine, according to the fourth indication and the fifth indication, whether the MCG failure recovery procedure is present.

In some embodiments, whether the MCG failure recovery procedure is present is determined as follows. When the fourth indication is received and the fifth indication is not received, the first protocol layer of the terminal device determines that the MCG failure recovery procedure is present.

In some embodiments, whether the MCG failure recovery procedure is present is determined as follows. The first protocol layer of the terminal device determines, according to a first variable, whether the MCG failure recovery procedure is present, where an initial value of the first variable is a first value, the first variable is set to a second value when the fourth indication is received by the first protocol layer, and the first variable is set to the first value when the fifth indication is received by the first protocol layer.

Specifically, when the first variable is the second value, it is determined that the MCG failure recovery procedure is present. When the first variable is the first value, it is determined that the MCG failure recovery procedure is absent.

For example, the first value is 0, and the second value is 1. The initial value of the first variable is 0, the first variable is set to 1 when the fourth indication (the second protocol layer triggers the MCG failure recovery procedure) is received, and the first variable is set to 0 when the fifth indication (the MCG failure recovery procedure is completed or canceled) is received. When the first variable is 1, the MAC layer of the terminal device determines that the MCG failure recovery procedure is present. When the first variable is 0, the MAC layer of the terminal device determines that the MCG failure recovery procedure is absent.

In some embodiments, when the MCG failure recovery procedure is absent, the terminal device executes the LTM-related procedure as follows. When the MCG failure recovery procedure is absent, the first protocol layer of the terminal device initiates the LTM-related procedure.

Optionally, the first protocol layer may initiate an LTM procedure related to the first protocol layer and indicate the second protocol layer to initiate an LTM procedure related to the second protocol layer.

In some embodiments, the method for mobility management further includes the following. When the MCG failure recovery procedure is present, the first protocol layer of the terminal device ignores or discards the first signaling.

As mentioned above, in embodiments of the present disclosure, whether the MCG failure recovery procedure is present may be determined by the terminal device, such that the terminal device can execute the LTM-related procedure when the MCG failure recovery procedure is absent. Alternatively, the LTM-related procedure may be triggered when the MCG failure recovery procedure is absent on the terminal device, thereby eliminating the need for the terminal device to perform determination when the terminal device receives the first signaling used for triggering the LTM-related procedure.

Specifically, in some embodiments, when the MCG failure recovery procedure is absent, the terminal device executes the LTM-related procedure as follows. When the first signaling is received by the terminal device, the terminal device executes the LTM-related procedure, where the first signaling is transmitted when the MCG failure recovery procedure is absent on the terminal device.

In other words, the transmission of the first signaling is triggered when the MCG failure recovery procedure is absent on the terminal device. As such, reception of the first signaling by the terminal device means that the MCG failure recovery procedure is currently absent, and thus the LTM-related procedure can be executed.

In some embodiments, the method for mobility management further includes the following. When the MCG failure recovery procedure is triggered by the terminal device, the terminal device executes a first processing, where the first processing is used for preventing the terminal device or the network device from triggering LTM-related signaling transmission.

Optionally, the first processing is used for preventing the terminal device or the network device from triggering SCG side-LTM related signaling transmission.

Since LTM-related processing is primarily implemented based on the first protocol layer, in some embodiments, the first protocol layer is required to implement the first processing to avoid triggering the LTM-related signaling transmission during the MCG failure recovery procedure. In some embodiments, when the MCG failure recovery procedure is triggered by the terminal device, the terminal device can execute the first processing as follows. When the MCG failure recovery procedure is triggered by the second protocol layer of the terminal device, the second protocol layer of the terminal device sends a sixth indication to the first protocol layer of the terminal device. When the sixth indication is received by the first protocol layer of the terminal device, the first protocol layer of the terminal device executes the first processing. The sixth indication can indicate that the MCG failure recovery procedure is currently triggered.

Specifically, when the MCG failure recovery procedure is triggered, an upper layer of the terminal device can send the sixth indication to a lower layer, and the lower layer executes the first processing to prevent triggering of the SCG side-LTM related signaling transmission, i.e., to prevent the terminal device from receiving the first signaling during the MCG failure recovery procedure, such that the LTM-related procedure will not be executed.

In some embodiments, the first processing includes the following. An L1 measurement and/or reporting of an L1 measurement report on an LTM candidate cell for an SCG is stopped.

The L1 measurement on the LTM candidate cell for the SCG is stopped, and/or the reporting of the L1 measurement report on the LTM candidate cell for the SCG is stopped, such that the network device is unable to make an LTM decision, and thus will not trigger the first signaling.

Correspondingly, when the MCG failure recovery procedure is completed or canceled, the second protocol layer can send indication information to the first protocol layer to indicate the first protocol layer to resume the L1 measurement and/or the reporting of the L1 measurement report.

In some embodiments, the first processing includes the following. A seventh indication is sent to the network device, where the seventh indication is used for the network device to determine that the MCG failure recovery procedure is present on the terminal device.

Optionally, the network device may be an SN distributed unit (DU). For the network, an LTM procedure is triggered by a DU, an RRC procedure is processed by a centralized unit (CU), and thus the DU is unaware of whether the MCG failure information is received by the CU. According to the foregoing embodiment, the lower layer of the terminal device processing the LTM can send the seventh indication to the SN DU, such that the DU can determine that the MCG failure recovery procedure is present on the terminal device. When the MCG failure recovery procedure is present on the terminal device, the DU can stop making any LTM-related decision and performing signaling transmission.

In some embodiments, the method for mobility management may further include the following. When the MCG failure recovery procedure is completed or canceled, the second protocol layer of the terminal device sends an eighth indication to the first protocol layer of the terminal device, where the eighth indication indicates the first protocol layer to send a ninth indication to the network device, and the ninth indication is used for the network device to determine the completion or cancellation of the MCG failure recovery procedure on the terminal device.

Specifically, the ninth indication can enable the network device to resume making the LTM-related decision and performing signaling transmission.

As can be seen, in the present disclosure, a solution is proposed from the terminal side to avoid triggering the LTM-related procedure for the SCG side during the MCG failure recovery procedure. According to embodiments of the present disclosure, a change in the network situation caused by the LTM-related procedure can be avoided during the MCG failure recovery procedure, thereby improving the success rate of the MCG failure recovery procedure and ensuring system stability.

FIG. 6 is a schematic flowchart of a method for mobility management according to another embodiment of the present disclosure. The method is optionally applicable to the system as illustrated in FIG. 1, but is not limited thereto. The method includes the following.

At S610, when an MCG failure recovery procedure is absent on a terminal device, a first network device triggers an LTM-related procedure for an SCG for the terminal device.

It can be understood that, the first network device is a network device configured to trigger the LTM-related procedure for the SCG. For example, the first network device may be an SN DU (a DU of an SN).

In this embodiment, a solution is proposed from the network side to avoid triggering the LTM-related procedure for the SCG side during the MCG failure recovery procedure. According to the embodiment, a change in a network condition caused by the LTM-related procedure can be avoided during the MCG failure recovery procedure, thereby improving the success rate of the MCG failure recovery procedure and ensuring system stability.

Optionally, when the MCG failure recovery procedure is present on the terminal device, the first network device will not trigger the LTM-related procedure for the SCG for the terminal device, for example, not making any LTM-related decision and/or performing related signaling transmission.

In some embodiments, the method for mobility management further includes the following. The first network device receives a seventh indication, where the seventh indication is used for the first network device to determine that the MCG failure recovery procedure is present on the terminal device, and the seventh indication is sent by the terminal device or a second network device.

In other words, in some embodiments, the terminal device or the second network device informs the first network device that the MCG failure recovery procedure is currently present on the terminal device.

Exemplarily, the second network device may be a network device on an SCG link that receives or processes MCG failure information. For example, the second network device may be an SN CU (a CU of an SN).

Optionally, the seventh indication sent by the first network device to the second network device may be carried in an F1 application protocol (F1AP) message.

In some embodiments, the method for mobility management further includes the following. The first network device receives a ninth indication, where the ninth indication is used for the first network device to determine completion or cancellation of the MCG failure recovery procedure on the terminal device, and the ninth indication is sent by the terminal device or the second network device.

Optionally, when the ninth indication is received by the first network device, the first network device can determine the completion or cancellation of the MCG failure recovery procedure. In this way, the first network device can resume the LTM-related procedure.

Optionally, the ninth indication sent by the first network device to the second network device may be carried by an F1AP message.

It can be understood that, in practical applications, the method for mobility management performed by the first network device may also be implemented in combination with the method for mobility management performed by the terminal device in the foregoing embodiment. For example, the SN DU can stop triggering the LTM-related procedure for the SCG side for the terminal device when the seventh indication is received. Also, the terminal device can determine whether the MCG failure recovery procedure is present when the first signaling is received, and based on a determination that the MCG failure recovery procedure is absent, the terminal device executes the LTM-related procedure. The terminal device or the SN CU may also send the seventh indication to the SN DU when the MCG failure recovery procedure is triggered, such that the SN DU stops making any LTM-related decision and performing signaling transmission.

FIG. 7 is a schematic flowchart of a method for mobility management according to yet another embodiment of the present disclosure. The method is optionally applicable to the system as illustrated in FIG. 1, but is not limited thereto. The method includes the following.

At S710, a second network device sends a seventh indication to a first network device, where the seventh indication is used for the first network device to determine that an MCG failure recovery procedure is present on a terminal device, to cause the first network device to stop triggering an LTM-related procedure for an SCG for the terminal device.

Exemplarily, the second network device may be a network device on an SCG link that receives or processes MCG failure information. For example, the second network device may be an SN CU. The first network device may be a network device configured to trigger the LTM-related procedure for the SCG. For example, the first network device may be an SN DU. The SN CU sends to the SN DU indication information indicating that the MCG failure recovery procedure is present on the terminal device, such that the SN DU will not trigger the LTM-related procedure, which can avoid a change in a network situation caused by the LTM-related procedure during the MCG failure recovery procedure, thereby improving the success rate of the MCG failure recovery procedure and ensuring system stability.

In some embodiments, the method for mobility management further includes the following. The second network device sends a ninth indication to the first network device, where the ninth indication is used for the first network device to determine completion or cancellation of the MCG failure recovery procedure on the terminal device.

Optionally, when the ninth indication is received by the first network device, the first network device can determine the completion or cancellation of the MCG failure recovery procedure. In this way, the first network device can resume the LTM-related procedure.

It can be understood that, in practical applications, the method for mobility management performed by the second network device may also be implemented in combination with the method for mobility management performed by the terminal device in the foregoing embodiment. For example, the SN DU can stop triggering the LTM-related procedure for the SCG for the terminal device when the seventh indication is received. Also, the terminal device can determine whether the MCG failure recovery procedure is present when the first signaling is received, and based on a determination that the MCG failure recovery procedure is absent, the terminal device executes the LTM-related procedure. The terminal device or the SN DU may also send the seventh indication to the SN DU when the MCG failure recovery procedure is triggered, such that the SN DU stops making the LTM-related decision and performing signaling transmission.

Since the network side can determine whether an MCG failure occurs on the terminal side only when an RRC message is successfully received, and before this, the LTM procedure for the SCG may be triggered. Therefore, the method for mobility management performed by the network device and the method for mobility management performed by the terminal device are implemented together, such that the method on the terminal side can be used to ensure that the LTM-related procedure is avoided during the MCG failure recovery procedure.

To facilitate understanding of the technical solutions of embodiments of the present disclosure, several application examples are provided below to illustrate the implementation procedure of the method for mobility management in the present disclosure in chronological order.

### Application Example 1

The application example mainly includes the following UE-side solution.
1. When a first condition is satisfied, an RRC layer triggers a first procedure (e.g., the first procedure is an MCG failure recovery procedure), transmits an MCGFailureInformation message, and starts timer T316. The first condition may include: a) RLF occurs on an MCG side; b) SCG transmission is not suspended; c) an SCG is not deactivated; and d) no PSCell change or PSCell addition is ongoing, i.e., T304 used for PSCell change/addition is not running.
2. An MAC layer receives a first signaling (e.g., the first signaling is an MAC CE indicating LTM cell switch), and the MAC layer indicates to an upper layer (e.g., the RRC layer) that the first signaling is received by the MAC layer. Based on the following optional manners, an interaction between the RRC layer and the MAC layer further includes the following.
1 After the MAC layer receives the MAC CE indicating the LTM cell switch (i.e., an LTM cell switch command), the MAC layer sends indication information to the upper layer and executes an LTM-related procedure, for example, initiating a random access procedure to a target cell, applying a TCI state indicated, resetting an MAC, etc. After receiving the indication information from the MAC layer, the upper layer determines whether T316 is running. If T316 is running, the RRC layer indicates the MAC layer to cancel an ongoing LTM procedure, and/or initiates an RRC re-establishment procedure and stops T316. After receiving an LTM cancellation indication, the MAC layer stops the ongoing LTM procedure. Optionally, the MAC layer initiates a random access procedure to a source PSCell, and/or falls back to an MAC configuration related to the source PSCell. If T316 is not running, the RRC starts executing the LTM-related procedure.
After the MAC layer receives the MAC CE indicating the LTM cell switch (i.e., the LTM cell switch command), the MAC layer sends the indication information to the upper layer. After receiving an indication to execute the LTM from the upper layer, the MAC layer executes the LTM-related procedure. After receiving the indication information from the MAC layer, the upper layer determines whether T316 is running. If T316 is not running, the upper layer starts executing the LTM-related procedure and indicates the MAC layer to execute the LTM-related procedure.

### Application Example 2

The application example mainly includes the following UE-side solution.

1. When a first condition is satisfied, an RRC layer triggers a first procedure (e.g., the first procedure is an MCG failure recovery procedure), transmits an MCG failure information message, and starts T316. The RRC layer further performs the following operations.
a) The RRC layer indicates to the MAC layer whether an ongoing first procedure is currently present, whether the MCG failure recovery procedure is triggered, or whether T316 is running. Optionally, only when a candidate cell configuration for an SCG LTM is present, the RRC needs to indicate to the MAC layer whether the ongoing first procedure is present currently, whether the MCG failure recovery procedure is triggered, or whether T316 is running.
b) When the candidate cell configuration for the SCG LTM is present, the RRC layer indicates a lower layer to stop an L1 measurement and/or reporting of an L1 measurement report on an SCG LTM candidate cell, or indicates the MAC layer to send an MAC CE to the SCG, where the MAC CE indicates to an SN DU whether the MCG failure recovery procedure is currently triggered.
c) When a condition for stopping T316 is met, the RRC layer indicates to the MAC layer that the MCG failure recovery procedure is completed/cancelled, such that the MAC layer can determine that the MCG failure recovery procedure is completed/canceled, or resume the L1 measurement and/or the reporting of the L1 measurement report on the SCG LTM candidate cell, or send the MAC CE to an SN DU to indicate to the SN DU that the MCG failure recovery procedure is currently cancelled/completed.

2. The MAC layer receives a first signaling (e.g., the first signaling is an MAC CE indicating LTM cell switch), and determines whether an ongoing MCG failure recovery procedure is currently present on the RRC layer or whether the MCG failure recovery procedure is triggered by the RRC layer.
a) If the MAC layer determines that the ongoing MCG failure recovery procedure is currently present on the RRC layer, that the MCG failure recovery procedure is triggered by the RRC layer, or that T316 is running, the MAC layer will not trigger the LTM procedure. Optionally, the UE/MAC layer ignores or discards the MAC CE indicating the LTM cell switch.
b) Otherwise, the MAC layer initiates the LTM procedure.

3. The MAC layer determines whether the ongoing MCG failure recovery procedure is currently present on the RRC layer or whether the MCG failure recovery procedure is triggered by the RRC layer in the following manner.
a) Whether the indication at 1a) (whether the ongoing first procedure is currently present, whether the MCG failure recovery procedure is triggered, or whether T316 is running) from the upper layer is received, and the indication at 1c) (the MCG failure recovery procedure is completed/cancelled) from the upper layer is not received.
b) A first variable is introduced at the MAC layer, and an initial value of the first variable is set to 0. When the indication at 1a) is received, the first variable is set to 1. When the indication at 1c) is received, the first variable is set to 0. The MAC layer determines, based on the value of the first variable, whether the ongoing MCG failure recovery procedure is present.

### Application Example 3

The application example primarily includes the following network-layer solution.
1. An SN CU receives a ULInformationTransferMRDC message carried by a UE via split SRB1 or SRB3, and the ULInformationTransferMRDC message contains MCGFailureInformation. The SN CU sends first indication information to an SN DU via an F1AP message, where the first indication information is used for informing the SN DU that an MCG failure recovery procedure is triggered by the UE. Upon receiving the first indication information, the SN DU is unable to trigger an LTM procedure for an SCG side.
2. When the SN CU receives fast MCG recovery information sent by an MN CU (fast MCG recovery via SRB3 from MN to SN IE), the SN CU sends second indication information to the SN DU via an F1AP message, where the second indication information is used for informing the SN DU whether the MCG failure recovery procedure on the UE is completed.

As can be seen, in embodiments of the present disclosure, solutions are provided from the UE side and the network side, respectively, thereby avoiding triggering the LTM procedure for the SCG side in the MCG failure recovery procedure.

FIG. 8 is a schematic block diagram of a terminal device 800 according to an embodiment of the present disclosure. The terminal device 800 may include a first processing module 810. The first processing module 810 is configured to execute an LMT-related procedure when an MCG failure recovery procedure is absent.

In an implementation, the first processing module 810 is further configured to, in response to receiving a first signaling, determine whether the MCG failure recovery procedure is present, where the first signaling is used for triggering the LTM-related procedure.

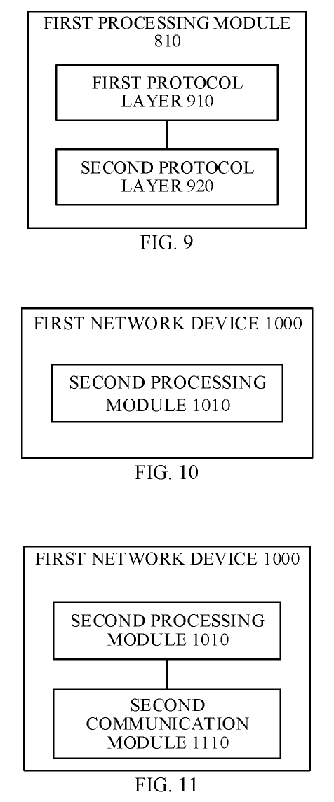

In an implementation, as illustrated in FIG. 9, the first processing module 810 includes a first protocol layer 910, where the first protocol layer 910 is configured to send a first indication to a second protocol layer of the terminal device in response to receiving a first signaling. The first processing module 810 further includes a second protocol layer 920, where the second protocol layer 920 is configured to determine, in response to receiving the first indication, whether the MCG failure recovery procedure is present.

In an implementation, the second protocol layer 920 is configured to determine, according to a running state of a first timer, whether the MCG failure recovery procedure is present, where the first timer is started in response to triggering of the MCG failure recovery procedure, and the first timer is stopped in response to completion or cancellation of the MCG failure recovery procedure.

In an implementation, the second protocol layer 920 is further configured to initiate an LTM procedure related to the second protocol layer based on a determination that the MCG failure recovery procedure is absent.

In an implementation, the second protocol layer 920 is further configured to, based on a determination that the MCG failure recovery procedure is present, send a second indication to the first protocol layer and/or initiate an RRC re-establishment procedure, where the second indication indicates the first protocol layer to cancel an LTM procedure related to the first protocol layer initiated in response to receiving the first signaling.

In an implementation, the first protocol layer 910 is further configured to, in response to receiving the second indication, initiate a random access procedure to a network device of a source PSCell and/or fall back to a configuration related to the source PSCell.

In an implementation, the second protocol layer 920 is further configured to send a third indication to the first protocol layer of the terminal device based on a determination that the MCG failure recovery procedure is absent. The first protocol layer 910 is further configured to initiate an LTM procedure related to the first protocol layer in response to receiving the third indication.

In an implementation, the second protocol layer 920 is further configured to initiate an RRC re-establishment procedure based on a determination that the MCG failure recovery procedure is present.

In an implementation, the second protocol layer 920 is configured to send a fourth indication to the first protocol layer of the terminal device in response to triggering the MCG failure recovery procedure, and the fourth indication is used for the first protocol layer of the terminal device to determine, in response to receiving the first signaling, whether the MCG failure recovery procedure is present.

In an implementation, the second protocol layer 920 is further configured to, in response to triggering the MCG failure recovery procedure, send the fourth indication to the first protocol layer of the terminal device when a candidate cell configuration for an SCG side-LTM is present.

In an implementation, the second protocol layer 920 is further configured to send a fifth indication to the first protocol layer in response to completion or cancellation of the MCG failure recovery procedure, where the fifth indication is used for the first protocol layer of the terminal device to determine, in response to receiving the first signaling, whether the MCG failure recovery procedure is present.

In an implementation, the first protocol layer 910 is configured to, in response to receiving the fourth indication and not receiving the fifth indication, determine that the MCG failure recovery procedure is present.

In an implementation, the first protocol layer 910 is further configured to determine, according to a first variable, whether the MCG failure recovery procedure is present, where an initial value of the first variable is 0, the first variable is set to 1 in response to the first protocol layer receiving the fourth indication, and the first variable is set to 0 in response to the first protocol layer receiving the fifth indication.

In an implementation, the first protocol layer 910 is further configured to initiate the LTM-related procedure when the MCG failure recovery procedure is absent.

In an implementation, the first protocol layer 910 is further configured to ignore or discard the first signaling when the MCG failure recovery procedure is present.

In an implementation, the first processing module 810 is further configured to execute the LTM-related procedure in response to receiving a first signaling, where the first signaling is transmitted when the MCG failure recovery procedure is absent on the terminal device.

In an implementation, the first processing module 810 is further configured to execute a first processing in response to triggering the MCG failure recovery procedure, where the first processing is used for preventing the terminal device or a network device from triggering LTM-related signaling transmission.

In an implementation, the second protocol layer 920 is further configured to send a sixth indication to the first protocol layer of the terminal device in response to triggering the MCG failure recovery procedure. The first protocol layer is configured to execute the first processing in response to receiving the sixth indication.

In an implementation, the first processing includes stopping an L1 measurement and/or reporting of an L1 measurement report on an LTM candidate cell for an SCG.

In an implementation, the first processing includes sending a seventh indication to the network device, where the seventh indication is used for the network device to determine that the MCG failure recovery procedure is present on the terminal device.

In an implementation, the second protocol layer 920 is further configured to send an eighth indication to the first protocol layer of the terminal device in response to completion or cancellation of the MCG failure recovery procedure, where the eighth indication indicates the first protocol layer to send a ninth indication to the network device, and the ninth indication is used for the network device to determine the completion or cancellation of the MCG failure recovery procedure on the terminal device.

The terminal device 800 in embodiments of the present disclosure can implement corresponding functions of the terminal device in the foregoing method embodiments. For the procedure, function, implementation, and advantage corresponding to each module (sub-module, unit, or assembly, etc.) in the terminal device 800, reference can be made to the corresponding illustrations in the foregoing method embodiments, which will not be repeated herein. It may be noted that, the functions of various modules (sub-modules, units, or assemblies, etc.) in the terminal device 800 in embodiments of the present disclosure may be implemented by different modules (sub-modules, units, or assemblies, etc.), or may be implemented by the same module (sub-module, unit, or assembly, etc.).

FIG. 10 is a schematic block diagram of a first network device 1000 according to an embodiment of the present disclosure. The first network device 1000 may include a second processing module 1010. The second processing module 1010 is configured to trigger an LMT-related procedure for an SCG for a terminal device when an MCG failure recovery procedure is absent on the terminal device.

In an implementation, as illustrated in FIG. 11, the first network device 1000 further includes a first communication module 1110, and the first communication module 1110 is configured to receive a seventh indication, where the seventh indication is used to determine that the MCG failure recovery procedure is present on the terminal device, and the seventh indication is sent by the terminal device or a second network device.

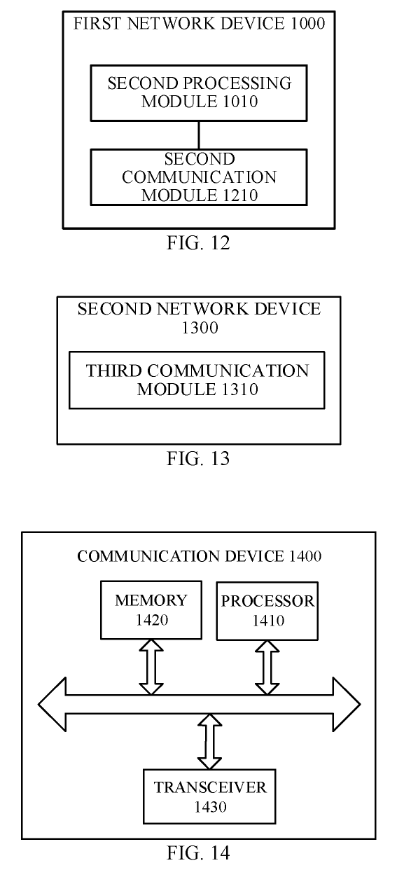

In an implementation, as illustrated in FIG. 12, the first network device 1000 further includes a second communication module 1210, and the second communication module 1210 is configured to receive a ninth indication, where the ninth indication is used to determine completion or cancellation of the MCG failure recovery procedure on the terminal device, and the ninth indication is sent by the terminal device or a second network device.

The first network device 1000 in embodiments of the present disclosure can implement corresponding functions of the terminal device in the foregoing method embodiments. For the procedure, function, implementation, and advantage corresponding to each module (sub-module, unit, or assembly, etc.) in the first network device 1000, reference can be made to the corresponding illustrations in the foregoing method embodiments, which will not be repeated herein. It may be noted that, the functions of various modules (sub-modules, units, or assemblies, etc.) in the first network device 1000 in embodiments of the present disclosure may be implemented by different modules (sub-modules, units, or assemblies, etc.), or may be implemented by the same module (sub-module, unit, or assembly, etc.).

FIG. 13 is a schematic block diagram of a second network device 1300 according to an embodiment of the present disclosure. The second network device of 1300 may include a third communication module 1310. The third communication module 1310 is configured to send a seventh indication to a first network device, where the seventh indication is used for the first network device to determine that an MCG failure recovery procedure is present on a terminal device, to cause the first network device to stop triggering an LMT-related procedure for an SCG for the terminal device.

In an implementation, the third communication module 1310 is further configured to send a ninth indication to the first network device, where the ninth indication is used for the first network device to determine completion or cancellation of the MCG failure recovery procedure on the terminal device.

The second network device 1300 in embodiments of the present disclosure can implement corresponding functions of the terminal device in the foregoing method embodiments. For the procedure, function, implementation, and advantage corresponding to each module (sub-module, unit, or assembly, etc.) in the second network device 1300, reference can be made to the corresponding illustrations in the foregoing method embodiments, which will not be repeated herein. It may be noted that, the functions of various modules (sub-modules, units, or assemblies, etc.) in the second network device 1300 in embodiments of the present disclosure may be implemented by different modules (sub-modules, units, or assemblies, etc.), or may be implemented by the same module (sub-module, unit, or assembly, etc.).

FIG. 14 is a schematic structural diagram of a communication device 1400 according to embodiments of the present disclosure. The communication device 1400 includes a processor 1410. The processor 1410 can invoke and execute a computer program stored in a memory, to cause the communication device 1400 to implement the method in embodiments of the present disclosure.

In an implementation, the communication device 1400 may further include a memory 1420. The processor 1410 can invoke and execute a computer program stored in the memory 1420, to cause the communication device 1400 to implement the method in embodiments of the present disclosure.

The memory 1420 may be a separate device independent of the processor 1410, or may be integrated into the processor 1410.

In an implementation, the communication device 1400 may further include a transceiver 1430. The processor 1410 may control the transceiver 1430 to communicate with other devices. Specifically, the processor 1410 may control the transceiver 1430 to send information or data to, or receive information or data from, other devices.

The transceiver 1430 may include a transmitter and a receiver. The transceiver 1430 may further include one or more antennas.

In an implementation, the communication device 1400 may specifically be the terminal device in embodiments of the present disclosure, and the communication device 1400 may implement corresponding operations implemented by the terminal device in various methods in embodiments of the present disclosure, which will not be repeated herein for the sake of brevity.

In an implementation, the communication device 1400 may specifically be the first network device in embodiments of the present disclosure, and the communication device 1400 may implement corresponding operations implemented by the first network device in various methods in embodiments of the present disclosure, which will not be repeated herein for the sake of brevity.

In an implementation, the communication device 1400 may specifically be the second network device in embodiments of the present disclosure, and the communication device 1400 may implement corresponding operations implemented by the second network device in various methods in embodiments of the present disclosure, which will not be repeated herein for the sake of brevity.

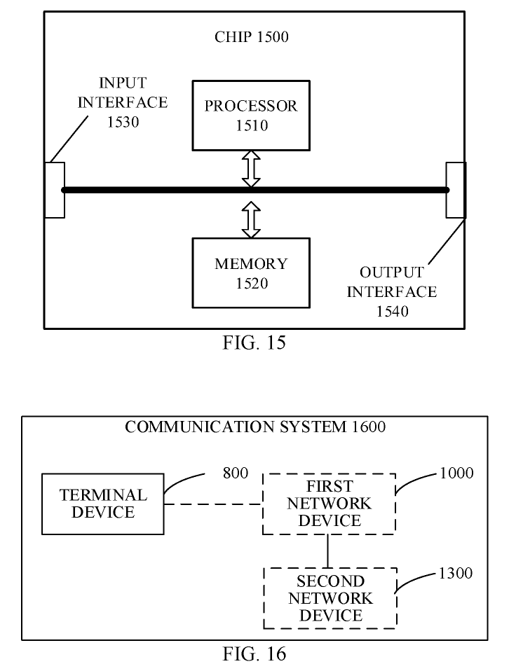

FIG. 15 is a schematic structural diagram of a chip according to embodiments of the present disclosure. The chip 1500 includes a processor 1510. The processor 1510 can invoke and execute a computer program stored in a memory to implement the method in embodiments of the present disclosure.

In an implementation, the chip 1500 may further include a memory 1520. The processor 1510 can invoke and execute a computer program stored in the memory 1520 to implement the method performed by the terminal device or the network device in embodiments of the present disclosure.

The memory 1520 may be a separate device independent of the processor 1510, or may be integrated into the processor 1510.

In an implementation, the chip 1500 may further include an input interface 1530. The processor 1510 may control the input interface 1530 to communicate with other devices or chips. Specifically, the processor 1510 may obtain information or data sent by other devices or chips.

In an implementation, the chip 1500 may further include an output interface 1540. The processor 1510 may control the output interface 1540 to communicate with other devices or chips. Specifically, the processor 1510 may output information or data to other devices or chips.

In an implementation, the chip is applicable to the terminal device in embodiments of the present disclosure, and the chip may implement the corresponding operations performed by the terminal device in various methods in embodiments of the present disclosure, which will not be repeated herein for the sake of brevity.

In an implementation, the chip is applicable to the first network device in embodiments of the present disclosure, and the chip may implement the corresponding operations performed by the first network device in various methods in embodiments of the present disclosure, which will not be repeated herein for the sake of brevity.

In an implementation, the chip is applicable to the second network device in embodiments of the present disclosure, and the chip may implement the corresponding operations performed by the second network device in various methods in embodiments of the present disclosure, which will not be repeated herein for the sake of brevity.

The chips used in the terminal device, the first network device, and the second network device may be the same or different.

It may be understood that, the chip in embodiments of the present disclosure may also be referred to as a system-level chip, a system chip, a chip system, a system-on-chip (SOC), etc.

The processor may be a general-purpose processor, a digital signal processor (DSP), a field programmable gate array (FPGA), an application-specific integrated circuit (ASIC), or other programmable logic devices, discrete gates or transistor logic devices, discrete hardware components, etc. The general-purpose processor may be a microprocessor, or may be any conventional processor, etc.

It can be understood that, the memory may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or flash memory. The volatile memory may be a random access memory (RAM).

It may be understood that, the memory is intended for illustration rather than limitation. For example, the memory in embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. In other words, the memory in embodiments of the present disclosure is intended to include, but is not limited to, these and any other suitable types of memory.

FIG. 16 is a schematic block diagram of a communication system 1600 according to embodiments of the present disclosure. The communication system 1600 includes a terminal device 800. The terminal device 800 is configured to execute an LTM-related procedure when an MCG failure recovery procedure is absent.

Optionally, the communication system 1600 may further include a first network device 1000. The first network device 1000 is configured to trigger an LTM-related procedure for an SCG for a terminal device when the MCG failure recovery procedure is absent on the terminal device. The first network device 1000 can determine, according to interaction with the terminal device 800 or other network devices, whether the MCG failure recovery procedure is present on the terminal device 800.

Optionally, the communication system 1600 may further include a second network device 1300. The second network device 1300 is configured to send a seventh indication to the first network device 1000.

The terminal device 800 may be configured to implement corresponding functions implemented by the terminal device in the foregoing method, the first network device 1000 may be configured to implement corresponding functions implemented by the first network device in the foregoing method, and the second network device 1300 may be configured to implement corresponding functions implemented by the second network device in the foregoing method, which will not be repeated again herein for the sake of brevity.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some of the operations or functions of embodiments of the present disclosure are performed. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable medium or a data storage device, such as a server, a data center, or the like, which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It may be understood that, in various embodiments of the present disclosure, the magnitude of a sequence number of each process does not mean an order of execution, and the order of execution of each process may be determined by its function and an internal logic, and shall not constitute any limitation to the implementation of embodiments of the present disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

The foregoing elaborations are merely implementations of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A method for mobility management, comprising:
executing, by a terminal device, a layer 1 (L1)/layer 2 (L2) triggered mobility (LTM)-related procedure when a master cell group (MCG) failure recovery procedure is absent.

2. The method of claim 1, further comprising:
in response to receiving a first signaling, determining, by the terminal device, whether the MCG failure recovery procedure is present, wherein the first signaling is used for triggering the LTM-related procedure.

3. The method of claim 2, wherein in response to receiving the first signaling, determining, by the terminal device, whether the MCG failure recovery procedure is present comprises:
in response to receiving the first signaling, sending, by a first protocol layer of the terminal device, a first indication to a second protocol layer of the terminal device, wherein the second protocol layer is configured to trigger the MCG failure recovery procedure; and
in response to receiving the first indication, determining, by the second protocol layer of the terminal device, whether the MCG failure recovery procedure is present.

4. The method of claim 3, wherein the second protocol layer is configured to determine, according to a running state of a first timer, whether the MCG failure recovery procedure is present, wherein the first timer is started in response to triggering of the MCG failure recovery procedure, and the first timer is stopped in response to completion or cancellation of the MCG failure recovery procedure.

5. The method of claim 3, wherein executing, by the terminal device, the LTM-related procedure when the MCG failure recovery procedure is absent comprises:
initiating, by the second protocol layer of the terminal device, an LTM procedure related to the second protocol layer based on a determination that the MCG failure recovery procedure is absent.

6. The method of claim 3, further comprising:
based on a determination that the MCG failure recovery procedure is present, sending, by the second protocol layer of the terminal device, a second indication to the first protocol layer and/or initiating, by the second protocol layer of the terminal device, a radio resource control (RRC) re-establishment procedure,
wherein the second indication indicates the first protocol layer to cancel an LTM procedure related to the first protocol layer initiated in response to receiving the first signaling.

7. The method of claim 6, further comprising:
in response to receiving the second indication, initiating, by the first protocol layer of the terminal device, a random access procedure to a network device of a source primary secondary cell (PSCell) and/or falling back to, by the first protocol layer of the terminal device, a configuration related to the source PSCell.

8. The method of claim 3, further comprising:
sending, by the second protocol layer of the terminal device, a third indication to the first protocol layer of the terminal device based on a determination that the MCG failure recovery procedure is absent; and
initiating, by the first protocol layer of the terminal device, an LTM procedure related to the first protocol layer in response to receiving the third indication.

9. The method of claim 8, further comprising:
initiating, by the second protocol layer of the terminal device, an RRC re-establishment procedure based on a determination that the MCG failure recovery procedure is present.

10. The method of claim 1, wherein executing, by the terminal device, the LTM-related procedure when the MCG failure recovery procedure is absent comprises:
executing, by the terminal device, the LTM-related procedure in response to receiving a first signaling, wherein the first signaling is transmitted when the MCG failure recovery procedure is absent on the terminal device.

11. The method of claim 1, further comprising:
executing, by the terminal device, a first processing in response to triggering the MCG failure recovery procedure, wherein the first processing is used for preventing the terminal device or a network device from triggering LTM-related signaling transmission.

12. The method of claim 11, wherein executing, by the terminal device, the first processing in response to triggering the MCG failure recovery procedure comprises:
sending, by a second protocol layer of the terminal device, a sixth indication to a first protocol layer of the terminal device in response to triggering the MCG failure recovery procedure; and
executing, by the first protocol layer of the terminal device, the first processing in response to receiving the sixth indication.

13. The method of claim 12, wherein the first processing comprises:
stopping an L1 measurement and/or reporting of an L1 measurement report on an LTM candidate cell for an SCG.

14. The method of claim 12, wherein the first processing comprises:
sending a seventh indication to the network device, wherein the seventh indication is used for the network device to determine that the MCG failure recovery procedure is present on the terminal device.

15. The method of claim 14, further comprising:
sending, by the second protocol layer of the terminal device, an eighth indication to the first protocol layer of the terminal device in response to completion or cancellation of the MCG failure recovery procedure, wherein the eighth indication indicates the first protocol layer to send a ninth indication to the network device, and the ninth indication is used for the network device to determine the completion or cancellation of the MCG failure recovery procedure on the terminal device.

16. A terminal device, comprising:
a memory configured to store a computer program; and
a processor configured to invoke and execute the computer program stored in the memory, to cause the terminal device to:
execute a layer 1 (L1)/layer 2 (L2) triggered mobility (LTM)-related procedure when a master cell group (MCG) failure recovery procedure is absent.

17. The terminal device of claim 16, wherein the processor is further configured to cause the terminal device to:
in response to receiving a first signaling, determine whether the MCG failure recovery procedure is present, wherein the first signaling is used for triggering the LTM-related procedure.

18. The terminal device of claim 17, wherein the processor is configured to cause the terminal device to:
in response to receiving the first signaling, send, by a first protocol layer of the terminal device, a first indication to a second protocol layer of the terminal device, wherein the second protocol layer is configured to trigger the MCG failure recovery procedure; and
in response to receiving the first indication, determine, by the second protocol layer of the terminal device, whether the MCG failure recovery procedure is present.

19. The terminal device of claim 18, wherein the second protocol layer is configured to determine, according to a running state of a first timer, whether the MCG failure recovery procedure is present, wherein the first timer is started in response to triggering of the MCG failure recovery procedure, and the first timer is stopped in response to completion or cancellation of the MCG failure recovery procedure.

20. A chip comprising:
a processor configured to invoke and execute a computer program stored in a memory, to cause a device equipped with the chip to:
execute a layer 1 (L1)/layer 2 (L2) triggered mobility (LTM)-related procedure when a master cell group (MCG) failure recovery procedure is absent.
